(19) United States
(12) Patent Application Publication
(10) Pub. No.: US 2017/0284508 A1
(43) Pub. Date: Oct. 5, 2017

(54) Planetary Powertrain Configuration with a Ball Variator Continuously Variable Transmission Used as a Powersplit

(71) Applicant: Dana Limited, Maumee, OH (US)

(72) Inventor: Thibault G. Devreese, Aalter (BE)

(21) Appl. No.: 15/470,528

(22) Filed: Mar. 27, 2017

Related U.S. Application Data
(60) Provisional application No. 62/315,369, filed on Mar. 30, 2016.

(51) Int. Cl. F16H 1/22; F16H 15/50; F16H 61/664; F16H 15/40; F16H 37/04; F16H 15/52; F16H 15/28

(52) U.S. Cl. CPC F16H 1/22; F16H 15/52; F16H 15/503; F16H 15/28; F16H 15/40; F16H 37/046; F16H 61/6649; F16H 2037/0886

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having an array of balls, a planetary gearset coupled thereto and an arrangement of rotatable shafts with multiple gears and clutches that extend the ratio range of the variator. In some embodiments, clutches are coupled to the gear sets to enable synchronous shifting of gear modes.

### RELATED APPLICATION

The present application claims priority to and the benefit from Provisional U.S. Patent Application Ser. No. 62/315,369 filed on Mar. 30, 2016. The content of the above-noted patent application is hereby expressly incorporated by reference into the detailed description of the present application.

### BACKGROUND

A driveline including a continuously variable transmission allows an operator or a control system to vary a drive ratio in a stepless manner, permitting a power source to operate at its most advantageous operating point.

### SUMMARY

Provided herein is a continuously variable transmission including a first rotatable shaft operably coupleable to a source of rotational power; a second rotatable shaft aligned coaxial with the first rotatable shaft, the first rotatable shaft and the second rotatable shaft forming a main axis; a variator assembly having a first traction ring assembly and a second traction ring assembly in contact with a plurality of balls, wherein each ball of the plurality of balls has a tillable axis of rotation, the variator assembly is coaxial with the main axis; a first planetary gearset having a first sun gear operably coupled to the second rotatable shaft, a first planet carrier operably coupled to the first rotatable shaft, and a first ring gear coupled to the second traction ring assembly; a first-and-third mode clutch operably coupled to the first ring gear, the first-and-third mode clutch coaxial with the main axis; a countershaft arranged parallel to the main axis; a second planetary gear set coaxial with the countershaft, the second planetary gear set having a second sun gear, a second planet carrier, and a second ring gear; a third planetary gear set coaxial with the countershaft, the third planetary gear set having a third sun gear, a third planet carrier, and a third ring gear; a second-and-fourth mode clutch coaxial with the countershaft, the second-and-fourth mode clutch operably coupled to the second sun gear and the third sun gear; a first synchronizer clutch coaxial with the countershaft, the first synchronizer clutch operably coupled to the second ring gear; and a second synchronizer clutch coaxial with the countershaft, the second synchronizer clutch operably coupled to the third ring gear.

Provided herein is a method of operating a continuously variable transmission, the method including providing a continuously variable transmission including: a first rotatable shaft operably coupleable to a source of rotational power; a second rotatable shaft aligned coaxial with the first rotatable shaft, the first rotatable shaft and the second rotatable shaft forming a main axis; a variator assembly having a first traction ring assembly and a second traction ring assembly in contact with a plurality of balls, wherein each ball of the plurality of balls has a tillable axis of rotation, the variator assembly is coaxial with the main axis; a first planetary gearset having a first sun gear operably coupled to the second rotatable shaft, a first planet carrier operably coupled to the first rotatable shaft, and a first ring gear coupled to the second traction ring assembly; a first-and-third mode clutch operably coupled to the first ring gear, the first-and-third mode clutch coaxial with the main axis; a countershaft arranged parallel to the main axis; a second planetary gear set coaxial with the countershaft, the second planetary gear set having a second sun gear, a second planet carrier, and a second ring gear; a third planetary gear set coaxial with the countershaft, the third planetary gear set having a third sun gear, a third planet carrier, and a third ring gear; a second-and-fourth mode clutch coaxial with the countershaft, the second-and-fourth mode clutch operably coupled to the second sun gear and the third sun gear; a first synchronizer clutch coaxial with the countershaft, the first synchronizer clutch operably coupled to the second ring gear; and a second synchronizer clutch coaxial with the countershaft, the second synchronizer clutch operably coupled to the third ring gear; engaging the first-and-third mode clutch to operate in a first mode of operation and a third mode of operation; engaging the second-and-fourth mode clutch to operate in a second mode of operation and a fourth mode of operation.

Provided herein is a vehicle driveline including a power source, a variable transmission of any of described herein drivingly engaged with the power source, and a vehicle output drivingly engaged with the variable transmission.

Provided herein is a vehicle including the variable transmission of any one of the transmissions described herein.

Provided herein is a method including providing a variable transmission of any one of the transmissions described herein.

Provided herein is a method including providing a vehicle driveline of the kind described herein.

Provided herein is a method including providing a vehicle having any one of the transmission described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a planetary powersplit continuously variable transmission.

FIG. 5 is a table depicting operating modes and corresponding clutch engagement for the transmission of FIG. 4.

FIG. 6 is a schematic diagram depicting power flow through a powersplit variator assembly used in the transmission of FIG. 4.

FIG. 7 is another schematic diagram depicting power flow through a powersplit variator assembly used in the transmission of FIG. 4.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the preferred embodiments described.

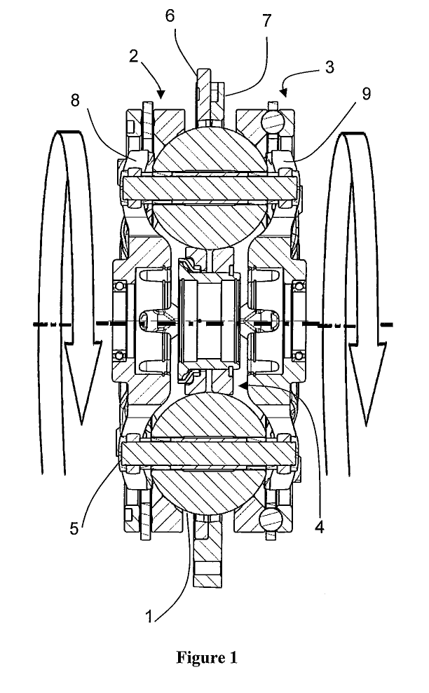

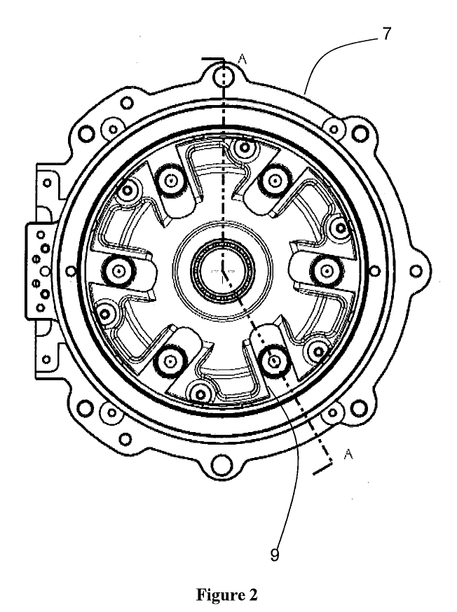

Provided herein are configurations of continuously variable transmissions (CVTs) based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

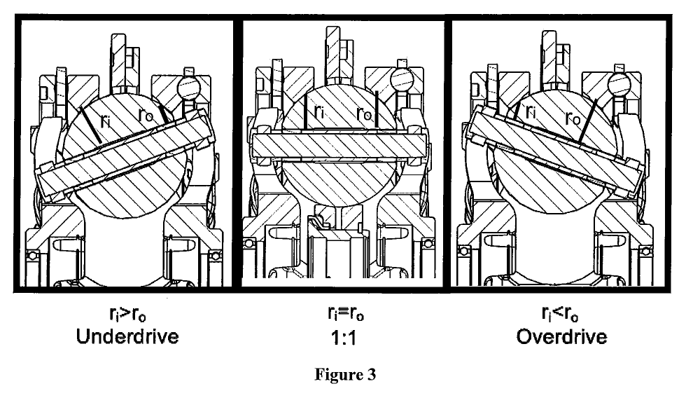

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

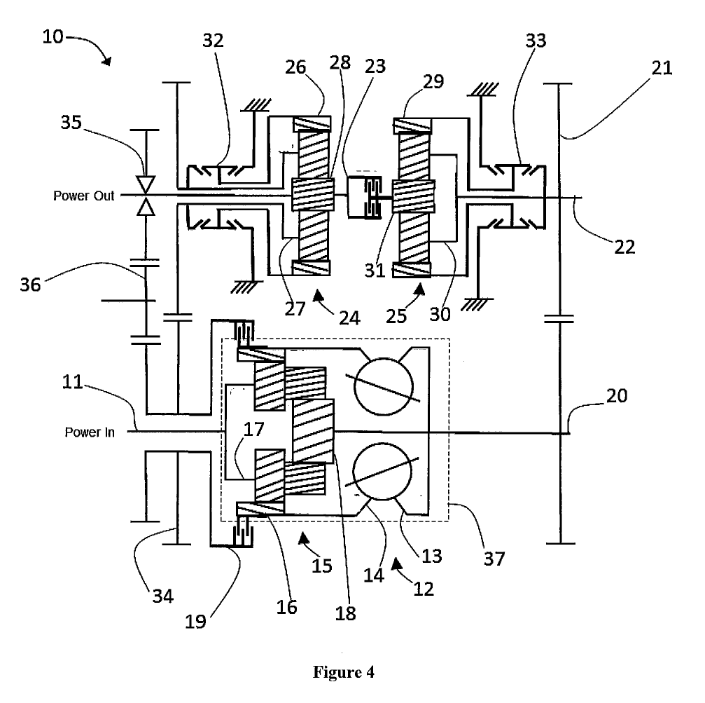

Referring now to FIG. 4, in some embodiments, a continuously variable transmission (CVT) 10 is provided with a first rotatable shaft 11 adapted to receive power from a source of rotational power. In some embodiments, the first rotatable shaft 11 is operably coupled to a torque converter device, or other common coupling. The CVT 10 is provided with a variator (CVP) 12 aligned coaxially with the first rotatable shaft 11. In some embodiments, the variator 12 is similar to the variator depicted in FIGS. 1-3. The variator 12 includes a first traction ring assembly 13 and a second traction ring assembly 14 in contact with a number of balls. In some embodiments, the CVT 10 includes a first planetary gear set 15 aligned coaxially with the first rotatable shaft 11 and the variator 12. The first planetary gear set 15 includes a first ring gear 16, a first planet carrier 17, and a first sun gear 18. In some embodiments, the first planet carrier 17 is coupled to the first rotatable shaft 11. In some embodiments, the first planet carrier 17 is operably coupled to a number of planet gears that are optionally configured as stepped gears. The first ring gear 16 is coupled to the second traction ring assembly 14. In some embodiments, a first-and-third mode clutch 19 is coupled to the ring gear 16. The sun gear 18 is coupled to a second rotatable shaft 20. The second rotatable shaft 20 is coaxial with the first rotatable shaft 11 and forms a main axis. In some embodiments, a first gear set 21 is configured to couple the second rotatable shaft 20 to a countershaft 22. The countershaft 22 is parallel to the main axis.

Still referring to FIG. 4, in some embodiments, the CVT 10 includes a second-and-fourth mode clutch 23 arranged coaxially with the countershaft 22. The second-and-fourth mode clutch 23 is operably coupled to a second planetary gear set 24 and a third planetary gear set 25. The second planetary gear set 24 and the third planetary gear set 25 are arranged coaxially with the countershaft 22. In some embodiments, the second planetary gear set 24 includes a second ring gear 26, a second planet carrier 27, and a second sun gear 28. In some embodiments, the third planetary gear set 25 includes a third ring gear 29, a third planet carrier 30, and a third sun gear 31. The second-and-fourth mode clutch 23 is configured to selectively couple the second sun gear 28 and the third sun gear 31. In some embodiments, the CVT 10 includes a first synchronizer clutch 32 arranged coaxially on the countershaft 22. The first synchronizer clutch 32 is operably coupled to the second ring gear 26. The CVT 10 includes a second synchronizer clutch 33 operably coupled to the third ring gear 29. In some embodiments, the first synchronizer clutch 32 is configured to selectively engage the second ring gear 26 and the second planet carrier 27. The second synchronizer clutch 33 is configured to selectively engage the third ring gear 29 to the third planet carrier 30.

Typically, synchronizer mechanisms (referred to herein as “synchronizer clutch”) used in power transmissions include a dog clutch integrated with a speed-matching device such as a cone-clutch. During operation of the transmission, if the dog teeth of the dog clutch make contact with a gear, and the two parts are spinning at different speeds, the teeth will fail to engage and a loud grinding sound will be heard as they clatter together. For this reason, a synchronizer mechanism or synchronizer clutch is used, which consists of a cone clutch. Before the teeth engage, the cone clutch engages first, which brings the two rotating elements to the same speed using friction. Until synchronization occurs, the teeth are prevented from making contact. It should be appreciated that the exact design of the synchronizer clutch is within a designer's choice for satisfying packaging and performance requirements. A synchronizer clutch is optionally configured to be a two position clutch having an engaged position and a neutral (or free) position. A synchronizer clutch is optionally configured to be a three position clutch having a first engaged position, a second engaged position, and a neutral position. Embodiments disclosed herein use synchronizer clutches to enable the pre-selection of gear sets by a control system (not shown) for smooth transition between operating modes of the transmission. It should be appreciated that the powertrain configurations disclosed herein are optionally configured with other types of selectable torque transmitting devices including, and not limited to, wet clutches, dry clutches, dog clutches, and electromagnetic clutches, among others.

Still referring to FIG. 4, in some embodiments, the CVT 10 includes a second gear set 34 configured to couple the second planet carrier 27 to the first-and-third mode clutch 19. The second gear set 34 includes, for example, two meshing gears, one of which is coaxial with the countershaft 22 and the other coaxial with the main axis. In some embodiments, the CVT 10 includes a reverse clutch 35 arranged coaxially with the countershaft 22. The reverse clutch 35 is optionally configured as a controllable clutch. For example, during operation of the CVT 10, the reverse clutch 35 is configured to operate as a bearing during forward direction of operation, and the reverse clutch 35 is configured to operate as a clutching device during reverse direction of operation. In some embodiments, a third gear set 36 operably couples the reverse clutch 35 to the first-and-third-mode clutch 19. The third gear set 36 optionally includes a number of meshing gears. For example, the third gear set 36 includes a gear arranged coaxially with the countershaft 22, an idler gear supported on a shaft arranged parallel to the countershaft, and a gear arranged coaxially with the main axis.

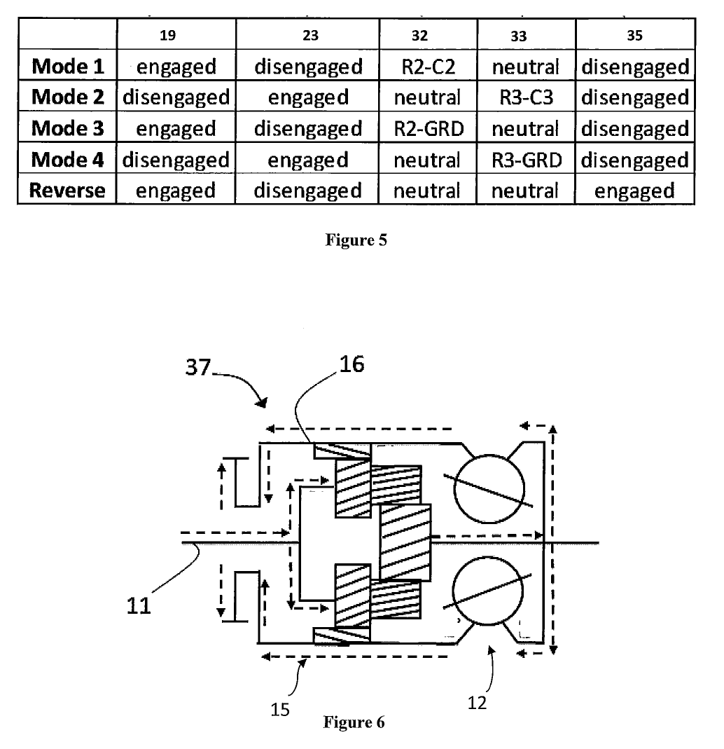

Turning now to FIG. 5, during operation of the CVT 10 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 10. The table depicted in FIG. 5, lists the modes of operation for the CVT 10 and indicates the corresponding clutch engagement. For mode 1 operation, the first-and-third mode clutch 19 is engaged while the second-and-fourth mode clutch 23 is disengaged. Mode 1 operation corresponds to the first synchronizer clutch 32 engaged in a position to thereby couple the second ring gear 26 and the second planet carrier 27. During mode 1 operation, the second synchronizer clutch 33 is in a neutral position or controlled to preselect engagement for mode 2 operation. For mode 2 operation, the second-and-fourth mode clutch 23 is engaged while the first-and-third mode clutch 19 is disengaged. Mode 2 operation corresponds to the second synchronizer clutch 33 engaged in a position to thereby couple the third ring gear 29 and the third planet carrier 30. During mode 2 operation, the first synchronizer clutch 32 is in a neutral position or controlled to preselect engagement for operating in mode 1 or in mode 3. For mode 3 operation, the first-and-third mode clutch 19 is engaged while the second-and-fourth mode clutch 23 is disengaged. Mode 3 operation corresponds to the first synchronizer clutch 32 engaged in a position to thereby couple the second ring gear 26 to a grounded member. During mode 3 operation, the second synchronizer clutch 33 is in a neutral position or controlled to preselect engagement for mode 2 or mode 4 operation. For mode 4 operation, the second-and-fourth mode clutch 23 is engaged whiled the first-and-third mode clutch 19 is disengaged. Mode 4 operation corresponds to the second synchronizer clutch 33 engaged in a position to thereby couple the third ring gear 29 to a grounded member. During mode 4 operation, the first synchronizer clutch 33 is in a neutral position or controlled to preselect engagement for mode 3 operation. For reverse operation, the first-and-third mode clutch 19 and the reverse clutch 35 are engaged while the second-and-fourth mode clutch 23 is disengaged. The first synchronizer clutch 32 and the second synchronizer clutch 33 are in neutral positions.

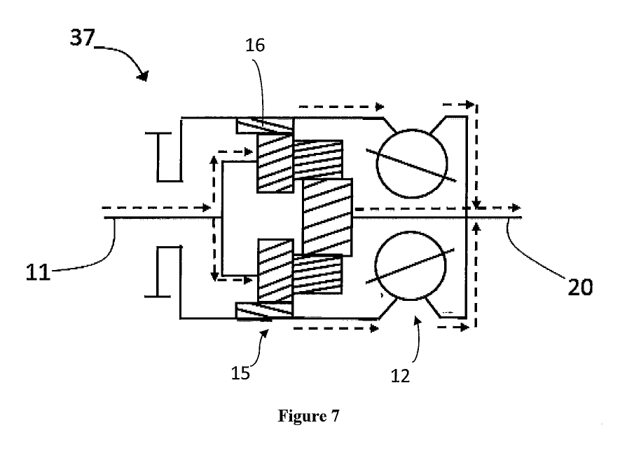

Referring now to FIGS. 6 and 7, and still referring to FIG. 4, in some embodiments, the first planetary gear set 15 and the variator 12 are collectively referred to as a powersplit variator assembly 37. It should be appreciated that the powersplit variator assembly 37 is optionally configured to have different couplings between the fixed ratio planetary portion and the variator portion. For example, the powersplit variator assembly 37 is optionally configured such as the power paths described in pending U.S. patent applications Ser. Nos. 15/423,131; 62/291,668; and 62/316,703, each of which are hereby incorporated by reference. During operation of the CVT 10, power flow through the powersplit variator assembly 37 for mode 1 and mode 3 operation is depicted with dashed arrows in FIG. 6. Rotational power comes in on the first rotatable shaft 11 and is transmitted out of the powersplit variator assembly 37 through the first ring gear 16. Power flow through the powersplit variator assembly 37 for mode 2 and mode 4 operation is depicted with dashed arrows in FIG. 7. Rotational power is transmitted on the first rotatable shaft 11 and is transmitted out of the powersplit variator assembly 37 through the second rotatable shaft 20.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable transmission comprising:
a first rotatable shaft operably coupleable to a source of rotational power;
a second rotatable shaft aligned coaxial with the first rotatable shaft, the first rotatable shaft and the second rotatable shaft forming a main axis;
a variator assembly having a first traction ring assembly and a second traction ring assembly in contact with a plurality of balls, wherein each ball of the plurality of balls has a tillable axis of rotation, the variator assembly is coaxial with the main axis;
a first planetary gearset having a first sun gear operably coupled to the second rotatable shaft, a first planet carrier operably coupled to the first rotatable shaft, and a first ring gear coupled to the second traction ring assembly;
a first-and-third mode clutch operably coupled to the first ring gear, the first-and-third mode clutch coaxial with the main axis;
a countershaft arranged parallel to the main axis;
a second planetary gear set coaxial with the countershaft, the second planetary gear set having a second sun gear, a second planet carrier, and a second ring gear;
a third planetary gear set coaxial with the countershaft, the third planetary gear set having a third sun gear, a third planet carrier, and a third ring gear;
a second-and-fourth mode clutch coaxial with the countershaft, the second-and-fourth mode clutch operably coupled to the second sun gear and the third sun gear;
a first synchronizer clutch coaxial with the countershaft, the first synchronizer clutch operably coupled to the second ring gear; and
a second synchronizer clutch coaxial with the countershaft, the second synchronizer clutch operably coupled to the third ring gear.

2. The continuously variable transmission of claim 1, further comprising a reverse clutch coupled to the countershaft.

3. The continuously variable transmission of claim 1, further comprising a first gear set coupled to the second rotatable shaft and the countershaft.

4. The continuously variable transmission of claim 1, further comprising a second gear set coupled to the second planet carrier and the first-and-third mode clutch.

5. The continuously variable transmission of claim 1, wherein the first synchronizer clutch is configured to selectively engage the second ring gear and the second planet carrier.

6. The continuously variable transmission of claim 1, wherein the second synchronizer clutch is configured to selectively engage the third ring gear and the third planet carrier.

7. The continuously variable transmission of claim 1, wherein the first synchronizer clutch is configured to selectively engage the second ring gear to ground.

8. The continuously variable transmission of claim 1, wherein the second synchronizer clutch is configured to selectively engage the third ring gear to ground.

9. A method of operating a continuously variable transmission, the method comprising:
providing a continuously variable transmission comprising:
a first rotatable shaft operably coupleable to a source of rotational power;
a second rotatable shaft aligned coaxial with the first rotatable shaft, the first rotatable shaft and the second rotatable shaft forming a main axis;
a variator assembly having a first traction ring assembly and a second traction ring assembly in contact with a plurality of balls, wherein each ball of the plurality of balls has a tillable axis of rotation, the variator assembly is coaxial with the main axis;
a first planetary gearset having a first sun gear operably coupled to the second rotatable shaft, a first planet carrier operably coupled to the first rotatable shaft, and a first ring gear coupled to the second traction ring assembly;
a first-and-third mode clutch operably coupled to the first ring gear, the first-and-third mode clutch coaxial with the main axis;
a countershaft arranged parallel to the main axis;
a second planetary gear set coaxial with the countershaft, the second planetary gear set having a second sun gear, a second planet carrier, and a second ring gear;
a third planetary gear set coaxial with the countershaft, the third planetary gear set having a third sun gear, a third planet carrier, and a third ring gear;
a second-and-fourth mode clutch coaxial with the countershaft, the second-and-fourth mode clutch operably coupled to the second sun gear and the third sun gear;
a first synchronizer clutch coaxial with the countershaft, the first synchronizer clutch operably coupled to the second ring gear; and
a second synchronizer clutch coaxial with the countershaft, the second synchronizer clutch operably coupled to the third ring gear;
engaging the first-and-third mode clutch to operate in a first mode of operation and a third mode of operation; and
engaging the second-and-fourth mode clutch to operate in a second mode of operation and a fourth mode of operation.

10. The method of claim 9, further comprising engaging the first synchronizer clutch to operate in the first mode of operation and the third mode of operation.

11. The method of claim 9, further comprising engaging the second synchronizer clutch to operate in the second mode of operation and the fourth mode of operation.

12. The method of claim 9, further comprising coupling the second ring gear with the second planet carrier to operate in a first mode of operation.

13. The method of claim 9, further comprising coupling the third ring gear and the third planet carrier to operate in a second mode of operation.

14. The method of claim 9, further comprising coupling the second ring gear to ground to operate in a third mode of operation.

15. The method of claim 9, further comprising coupling the third ring gear to ground to operate in a fourth mode of operation.

16. The continuously variable transmission of claim 1, wherein the variator assembly comprises a traction fluid.

17. A vehicle driveline comprising: a power source, a continuously variable transmission of

1. drivingly engaged with the power source, and a vehicle output drivingly engaged with the continuously variable transmission.

18. The vehicle driveline of claim 17, wherein the power source is drivingly engaged with the vehicle output.

19. A vehicle comprising the continuously variable transmission of claim 1.

20. A method comprising providing a continuously variable transmission of claim 1.
